(19) United States
(12) Patent Application Publication
(10) Pub. No.: US 2024/0244238 A1
(43) Pub. Date: Jul. 18, 2024

(54) INFORMATION PROCESSING SYSTEM, INFORMATION PROCESSING DEVICE, AND INFORMATION PROCESSING METHOD

(71) Applicant: SONY GROUP CORPORATION, TOKYO (JP)

(72) Inventor: TOSHINORI IHARA, TOKYO (JP)

(21) Appl. No.: 18/558,742

(22) PCT Filed: Mar. 14, 2022
(86) PCT No.: PCT/JP2022/011314

§ 371 Date: Nov. 3, 2023

(30) Foreign Application Priority Data
May 24, 2021 (JP) 2021-086854

(51) Int. Cl. H04N 19/37; H04N 19/184

(52) U.S. Cl. CPC H04N 19/37; H04N 19/184

(57) ABSTRACT

An information processing system (1) includes an information processing device (100) and a plurality of client devices. The information processing device (100) includes an encoder (120) that encodes data to be transmitted to encoded data of a plurality of different amounts of transmission, and a control unit (140) that performs control to transmit the encoded data encoded to a client device determined from among a plurality of client devices based on the amounts of transmission of the encoded data. Each of the client device includes a decoder that is adjusted to an amount of transmission to be decoded and decodes encoded data, and a second control unit that performs a process based on the decoded data.

### FIELD

The present disclosure relates to an information processing system, an information processing device, and an information processing method.

### BACKGROUND

A technique for realizing information compression using a neural network is known. Patent Literature 1 discloses a technique of realizing hierarchical encoding with high encoding efficiency and obtaining an image with image quality corresponding to a hierarchy when realizing hierarchical encoding using a neural network.

### CITATION LIST

### Patent Literature

Patent Literature 1: JP 2020-22145 A

### SUMMARY

### Technical Problem

In the conventional technique, in a case where one server device transmits data to a plurality of devices in real time, it is difficult to maintain real-time performance if video quality and a communication status required by the plurality of devices are different.

Therefore, the present disclosure provides an information processing system, an information processing device, and an information processing method capable of improving real-time performance in one-to-many communication.

### Solution to Problem

In order to solve the above problem, an information processing system according to one embodiment of the present disclosure includes: an information processing device; and a plurality of client devices, wherein the information processing device includes an encoder that encodes data to be transmitted to encoded data of a plurality of different amounts of transmission, and a control unit that performs control to transmit the encoded data encoded to a client device determined from among the plurality of client devices based on the amounts of transmission of the encoded data, wherein each of the client devices includes a decoder that is adjusted to an amount of transmission to be decoded and decodes the encoded data, and a second control unit that performs a process based on the decoded data.

In order to solve the above problem, an information processing device according to one embodiment of the present disclosure capable of communicating with a plurality of client devices, the information processing device includes: an encoder that encodes data to be transmitted to a plurality of pieces of encoded data having different amounts of transmission; and a control unit that performs control to transmit the encoded data encoded to a client device determined from among a plurality of client devices based on the amounts of transmission of the encoded data.

In order to solve the above problem, an information processing method according to one embodiment of the present disclosure includes: an information processing device capable of communicating with a plurality of client devices encoding data to be transmitted to a plurality of pieces of encoded data having different amounts of transmission by an encoder; and performing control to transmit the encoded data encoded to a client device determined from among a plurality of client devices based on the amounts of transmission of the encoded data.

### BRIEF DESCRIPTION OF DRAWINGS

FIG. 1 is a diagram for explaining an example of an information processing system according to an embodiment.

FIG. 2 is a diagram for explaining a configuration example of an encoder and a decoder of the information processing system according to the embodiment.

FIG. 3 is a diagram illustrating an example of a configuration of one hierarchy in the encoder and the decoder according to the embodiment.

FIG. 4 is a configuration diagram illustrating an example of a configuration of an information processing device according to the embodiment.

FIG. 5 is a configuration diagram illustrating an example of a configuration of a client device according to the embodiment.

FIG. 6 is a flowchart illustrating an example of a processing procedure related to encoding control of the information processing device.

FIG. 7 is a diagram illustrating an example of a data structure of transmission data.

FIG. 8 is a flowchart illustrating an example of a processing procedure related to decoding control of the client device.

FIG. 9 is a diagram illustrating an outline of a configuration example of an information processing system according to a modification of the embodiment.

FIG. 10 is a flowchart illustrating an example of a processing procedure related to encoding control of an information processing device according to a modification of the embodiment.

FIG. 11 is a flowchart illustrating an example of a processing procedure related to decoding control of a client device according to a modification of the embodiment.

FIG. 12 is a diagram for describing a usage example of temporal direction prediction of the information processing system.

FIG. 13 is a diagram for explaining an example of a training method of an auto encoder of the information processing system.

FIG. 14 is a diagram for describing an example of a training method of an auto encoder with priority given to a high bit rate.

FIG. 15 is a diagram for describing an example of a training method of an auto encoder with priority given to a low bit rate.

FIG. 16 is a hardware configuration diagram illustrating an example of a computer that implements functions of an information processing device.

### DESCRIPTION OF EMBODIMENTS

Hereinafter, the embodiments of the present disclosure will be described in detail with reference to the drawings. In the following embodiments, substantially the same parts are denoted by the same reference signs, and a duplicate description will be omitted.

### EMBODIMENT

### [Outline of Remote Operation System According to Embodiment]

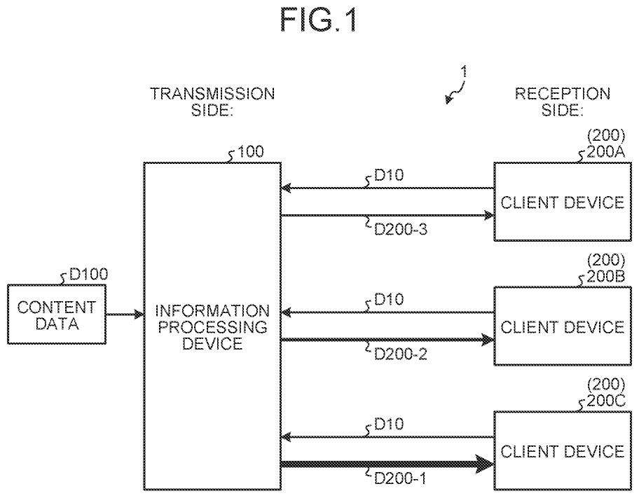

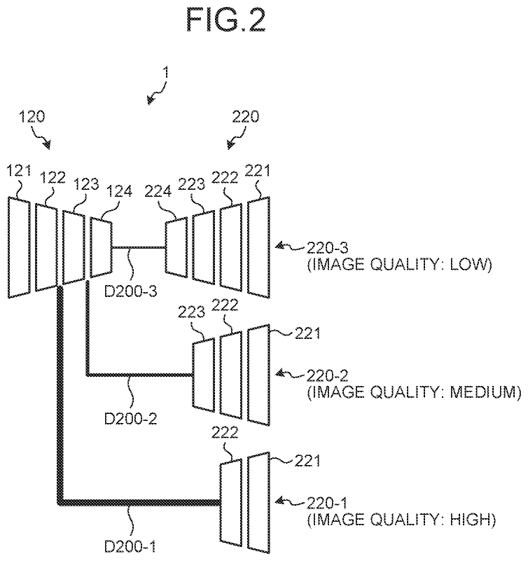

FIG. 1 is a diagram for describing an example of an information processing system according to an embodiment. FIG. 2 is a diagram for describing a configuration example of an encoder and a decoder of the information processing system according to the embodiment.

An information processing system 1 illustrated in FIG. 1 is a one-to-many communication system capable of distributing content to a plurality of clients in real time at a plurality of types of bit rates. The information processing system 1 can be applied to, for example, remote operation by a plurality of operators, remote creation of entertainment, and the like. The remote operation includes, for example, a system in which a plurality of workers operates the machine tool at the construction site from a remote place. The remote creation includes, for example, an entertainment system that performs switching, mixing, and editing of a camera shooting at a relay site.

The information processing system 1 has one information processing device 100 on the transmission side to transmit data to each of a plurality of client devices 200 on the reception side in real time. In this case, the plurality of client devices 200 may have different required image quality or different communication statuses. Therefore, the information processing system 1 provides a technology capable of improving real-time performance in one-to-many communication.

The information processing system 1 includes the information processing device 100 and a plurality of client devices 200. In the information processing system 1, the information processing device 100 and the plurality of client devices 200 are communicably connected via a network (not illustrated). The network is a wired or wireless transmission path of information transmitted from a device connected to the network. The network includes, for example, the Internet, a telephone network, a public network, a dedicated network, and the like. The information processing system 1 is a system that performs one-to-many communication between one information processing device 100 and a plurality of clients 20.

In the present embodiment, in the information processing system 1, a case where the client devices 200 are three client devices 200A, 200B, and 200C will be described, but the number of client devices 200 is not limited thereto. Note that, in a case where the client device 200A, the client device 200B, and the client device 200C are not distinguished, the client device 200A, the client device 200B, and the client device 200C will be referred to as a “client device 200”.

The information processing device 100 is, for example, a server device that distributes content data D100 to the client device 200. The content data D100 includes, for example, various pieces of data such as music data, video data, a game, and software. The music data includes, for example, data related to sound such as music, radio, and public lecture. The video data includes, for example, data such as a movie, a moving image, a television program, a photograph, and a document. The content data D100 is an example of data to be transmitted.

The information processing device 100 has a function of distributing transmission data D200-1, transmission data D200-2, and transmission data D200-3 of different amounts of transmission obtained by encoding the content data D100 to the client device 200. The transmission data D200-1 has a larger amount of transmission than the transmission data D200-2, and has an amount of transmission suitable for high image quality. The transmission data D200-2 has a larger amount of transmission than the transmission data D200-3, and has an amount of transmission suitable for normal image quality. Transmission data D200-1, transmission data D200-2, and transmission data D200-3 include data obtained by encoding content data D100.

The client device 200 has a function of outputting (playing back) the content distributed by the information processing device 100. Examples of the client device 200 include a mobile terminal, a computer, a video processing device, a game device, a home appliance, or the like. The client device 200 transmits control information D10 to the information processing device 100, and obtains content of quality require by the client from the information processing device 100. The control information D10 includes, for example, information capable of identifying the quality or the like of content required by the client.

As illustrated in FIG. 2, in the information processing system 1, the information processing device 100 has a function of distributing the same content to the client device 200 with different image quality. The information processing device 100 generates content obtained by combining the same content data at different bit rates using the encoder 120, and distributes (transmits) the content to the client device 200. The encoder 120 includes a hierarchy 121, a hierarchy 122, a hierarchy 123, and a hierarchy 124, and is connected in this order.

The hierarchy 121 encodes the input digital data according to the first rule to output the encoded data encoded. The first rule includes, for example, a rule for conversion to the first bit rate. The hierarchy 122 encodes the encoded data input from the hierarchy 121 according to the second rule to output the encoded data encoded. The second rule includes, for example, a rule for conversion to the second bit rate lower than the first bit rate. The second bit rate includes, for example, a high bit rate suitable for high image quality. The hierarchy 123 encodes the encoded data input from the hierarchy 122 according to the third rule to output the encoded data encoded. The third rule includes, for example, a rule for conversion to a third bit rate lower than the second bit rate. The third bit rate includes, for example, a standard bit rate suitable for a medium image quality. The hierarchy 124 encodes the encoded data input from the hierarchy 123 according to the fourth rule to output the encoded data encoded. The fourth rule includes, for example, a rule for conversion to a fourth bit rate lower than the third bit rate. The fourth bit rate includes, for example, a low bit rate suitable for low image quality.

The information processing device 100 transmits the transmission data D200-1, the transmission data D200-2, and the transmission data D200-3 including the encoded data of the bit rate suitable for the situation on the reception side among the encoded data output from the hierarchy 122, the hierarchy 123, and the hierarchy 124 of the encoder 120 to the client device 200. The situation on the reception side includes, for example, a communication band, image quality required by the client device 200, and the like. The transmission data D200-1 includes the decoded data decoded by the hierarchy 122, and has the largest amount of data. The transmission data D200-2 includes the decoded data decoded by the hierarchy 123, and the amount of data is smaller than that of the transmission data D200-1. The transmission data D200-3 includes the decoded data decoded by the hierarchy 124, and the amount of data is smaller than that of the transmission data D200-2.

The client device 200 decodes the transmission data D200 from the information processing device 100 using the decoder 220 corresponding to the encoder 120, and performs a process based on the decoded data. The process includes, for example, processing such as data output, data editing, and data management. In the example illustrated in FIG. 2, the client device 200 includes a decoder 220-1, a decoder 220-2, and a decoder 220-3 corresponding to the type of the decoded data. Note that, hereinafter, in a case where the decoder 220-1, the decoder 220-2, and the decoder 220-3 are not distinguished, the decoder 220-1, the decoder 220-2, and the decoder 220-3 will be referred to as a “decoder 220”. Note that the client device 200 may include at least one of the decoder 220-1, the decoder 220-2, and the decoder 220-3.

The decoder 220-1 includes a hierarchy 222 and a hierarchy 221, and is connected in this order. The hierarchy 222 receives the transmission data D200-1 transmitted by the information processing device 100, and decodes the transmission data according to the second rule of the hierarchy 122 of the encoder 120 to output the decoded data that has been decoded. The hierarchy 221 decodes the decoded data output from the hierarchy 222 according to the first rule of the hierarchy 121 to output the decoded data. As a result, the client device 200 obtains the decoded data output from the decoder 220-1 as the high-quality transmission data D200-1.

The decoder 220-2 includes a hierarchy 223, the hierarchy 222, and the hierarchy 221, and is connected in this order. The hierarchy 223 receives the transmission data D200-2 transmitted by the information processing device 100, and decodes the transmission data according to the third rule of the hierarchy 123 of the encoder 120 to output the decoded data that has been decoded. The hierarchy 222 decodes the decoded data output from the hierarchy 223 according to the second rule of the hierarchy 122 to output the decoded data. The hierarchy 221 decodes the decoded data output from the hierarchy 222 according to the first rule of the hierarchy 121 to output the decoded data. As a result, the client device 200 obtains the decoded data output from the decoder 220-2 as medium-quality transmission data D200-2.

The decoder 220-3 includes a hierarchy 224, the hierarchy 223, the hierarchy 222, and the hierarchy 221, and is connected in this order. The hierarchy 224 receives the transmission data D200-3 transmitted by the information processing device 100, and decodes the transmission data according to the fourth rule of the hierarchy 124 of the encoder 120 to output decoded data that has been decoded. The hierarchy 223 decodes the decoded data output from the hierarchy 224 according to the third rule of the hierarchy 123 to output the decoded data. The hierarchy 222 decodes the decoded data output from the hierarchy 223 according to the second rule of the hierarchy 122 to output the decoded data. The hierarchy 221 decodes the decoded data output from the hierarchy 222 according to the first rule of the hierarchy 121 to output the decoded data. As a result, the client device 200 obtains the decoded data output from the decoder 220-3 as the low quality transmission data D200-3.

In the example illustrated in FIG. 2, the information processing system 1 includes the encoder 120 and the decoder 220. In the information processing system 1, the encoder 120 and the decoder 220-1, the encoder 120 and the decoder 220-2, the encoder 120 and the decoder 220-3 constitute an auto encoder. The auto encoder is one of neural networks. The auto encoder means an algorithm for compressing input data once, leaving only important feature amounts, and then restoring the data to the original dimension again. The information processing device 100 combines one encoder 120 with the plurality of decoders 220-1, 220-2, and 220-3 to transmit data of an amount of transmission suitable for the client device 200 to the plurality of client devices 200.

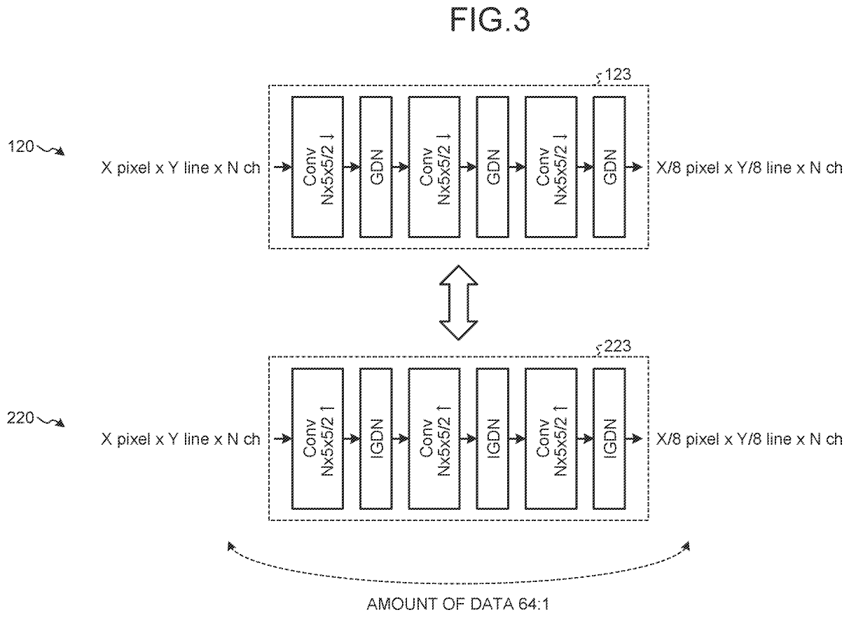

FIG. 3 is a diagram illustrating an example of a configuration of one hierarchy in each of the encoder 120 and the decoder 220 according to the embodiment. In the example illustrated in FIG. 3, only configuration examples of the hierarchy 123 of the encoder 120 and the hierarchy 223 of the decoder 220 illustrated in FIG. 2 are illustrated in order to simplify the description.

Data of X pixel×Y line×N ch is input to the hierarchy 123 of the encoder 120. The hierarchy 123 performs processing of lowering resolution by Conv, and performs processing of normalizing a processing result of Conv by GDN. The hierarchy 123 repeats these processing three times to output encoded data of X/8 pixel×Y/8 line×N ch. As a result, the information amount of the input data to the information amount of the output decoded data in the hierarchy 123 is 64:1.

Data of X/8 pixel×Y/8 line×N ch is input to the hierarchy 223 of the decoder 220. The hierarchy 223 repeats the processing of the IGDN and Conv corresponding to the encoder 120 three times to output the decoded data of X pixel×Y line×N ch. As a result, the information amount of the input data to the information amount of the transmission data to be output in the hierarchy 223 is 64:1.

The information processing device 100 reduces the amount of data of the transmission data D200-1, D200-2, and D200-3 output from the encoder 120 to 1/64 in this order with the hierarchy 123, the hierarchy 121, the hierarchy 122, and the hierarchy 124 illustrated in FIG. 3 having a similar configuration.

### [Configuration Example of Information Processing Device According to Embodiment]

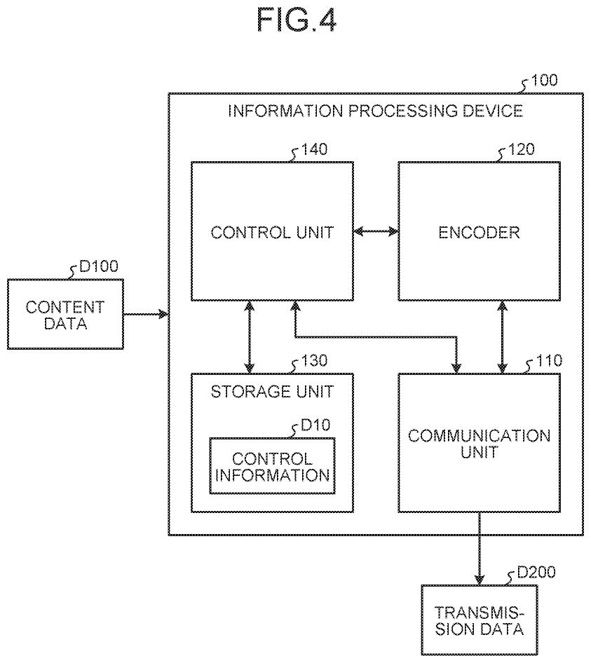

FIG. 4 is a configuration diagram illustrating an example of a configuration of the information processing device 100 according to the embodiment. As illustrated in FIG. 4, the information processing device 100 includes a communication unit 110, the encoder 120 described above, a storage unit 130, and a control unit 140. The control unit 140 is electrically connected to the communication unit 110, the encoder 120, and the storage unit 130.

The communication unit 110 communicates with, for example, a plurality of client devices 200 and other external devices. The communication unit 110 transmits and receives various types of information via a network or the like, for example. The communication unit 110 supplies, for example, various types of information received from the client device 200 to the control unit 140. For example, the communication unit 110 transmits information instructed by the control unit 140 to the instructed transmission destination. The communication protocol supported by the communication unit 110 is not particularly limited, and the communication unit 110 can support a plurality of types of communication protocols.

The encoder 120 encodes the content data D100 under the control of the control unit 140. The encoder 120 has a function of decoding the content data D100 transmitted by the information processing device 100 to a plurality of pieces of encoded data having different amounts of transmission. The encoder 120 can supply the encoded data encoded for each hierarchy to the communication unit 110 and the control unit 140.

The storage unit 130 stores various pieces of data and programs. The storage unit 130 is, for example, a semiconductor memory element such as a RAM or a flash memory, a hard disk, an optical disk, or the like. The storage unit 130 stores information received via the communication unit 110. The storage unit 130 stores, for example, various types of information such as the control information D10 described above. The control information D10 includes, for example, information that can identify the quality of the transmission data D200 required by the client device 200, the amount of transmission that can be decoded, and the like. The storage unit 130 may be an external storage device accessible by the information processing device 100.

The control unit 140 is an arithmetic processing device. The arithmetic processing device includes, for example, a central processing unit (CPU), a system-on-a-chip (SoC), a micro control unit (MCU), a field-programmable gate array (FPGA), and a coprocessor, but is not limited thereto. The control unit 140 is an integrated control unit that controls the information processing device 100.

Specifically, the control unit 140 executes a command included in the program stored in the storage unit 130 while referring to the information stored in the storage unit 130 as necessary. Then, the control unit 140 controls the functional unit according to the data and the command, thereby implementing various functions. The functional unit includes, for example, the communication unit 110, the encoder 120, and the like, but is not limited thereto. The control unit 140 has a function of controlling transmission of the transmission data D200 to the plurality of client devices 200 by executing a program.

The control unit 140 performs control to transmit the encoded data encoded to the client device 200 determined from among the plurality of client devices 200 based on the amounts of transmission of the encoded data. The control unit 140 performs control to transmit the encoded data encoded by each of the plurality of hierarchies of the encoder 120 to the client device 200 determined from among the plurality of client devices 200 based on the amounts of transmission of the encoded data. Every time a plurality of hierarchies of the encoder 120 performs encoding, the control unit 140 performs control to transmit encoded data encoded to the client device 200 determined from among the plurality of client devices 200 based on the amounts of transmission of the encoded data.

The control unit 140 has a function of determining the client device 200 that transmits the encoded data based on the amount of transmission indicated by the control information D10 from the client device 200. The control unit 140 identifies data quality, a communication status, and the like required by the client device 200, and obtains an amount of transmission suitable for the identified result. The control unit 140 transmits, to the client device 200, the transmission data D200 including the encoded data and hierarchy information capable of identifying the hierarchy of the encoded encoder 120.

The functional configuration example of the information processing device 100 according to the embodiment is described above. Note that the configuration described above with reference to FIG. 4 is merely an example, and the functional configuration of the information processing device 100 according to the embodiment is not limited to such an example. The functional configuration of the information processing device 100 according to the embodiment can be flexibly modified according to specifications and operations.

### [Configuration Example of Client Device According to Embodiment]

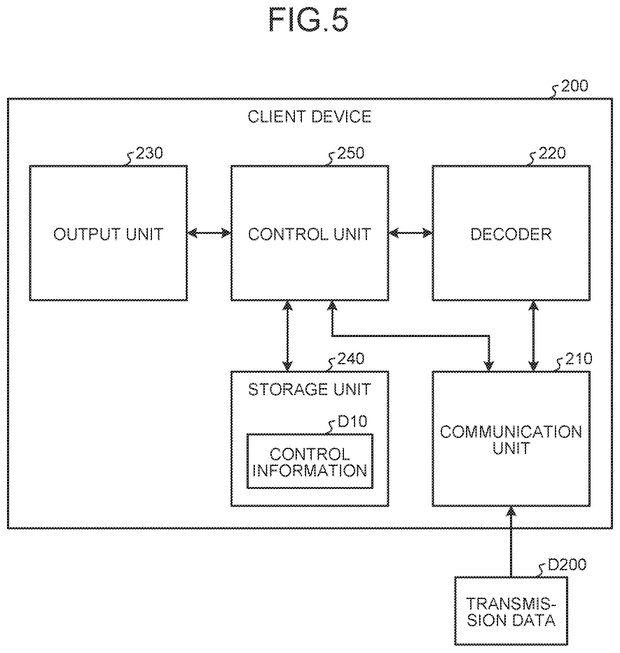

FIG. 5 is a configuration diagram illustrating an example of a configuration of the client device 200 according to the embodiment. As illustrated in FIG. 5, the client device 200 includes a communication unit 210, the decoder 220 described above, an output unit 230, a storage unit 240, and a control unit 250. The control unit 250 is electrically connected to the communication unit 210, the decoder 220, the output unit 230, and the storage unit 240.

The communication unit 210 communicates with, for example, the information processing device 100, other external devices, and the like. The communication unit 210 transmits and receives various types of information via a network or the like, for example. The communication unit 210 supplies, for example, various types of information received from the information processing device 100 to the control unit 250. For example, the communication unit 210 transmits information instructed by the control unit 250 to the instructed transmission destination. The communication protocol supported by the communication unit 210 is not particularly limited, and the communication unit 210 can support a plurality of types of communication protocols.

The decoder 220 decodes the transmission data D200 under the control of the control unit 250. The decoder 220 decodes the transmission data D200 using a hierarchy corresponding to a hierarchy, of the encoder 120, that performed encoding based on the hierarchy information included in the transmission data D200. The decoder 220 can supply the decoded data to the control unit 250. The decoder 220 may include the decoder 220-1, the decoder 220-2, and the decoder 220-3 described above, or may include at least one adjusted to a necessary amount of data of the decoder 220-1, the decoder 220-2, and the decoder 220-3.

The output unit 230 outputs data decoded by the decoder 220 under the control of the control unit 250. The output unit 230 includes, for example, a display, a speaker, and the like. The output unit 230 may be realized by a device outside the client device 200 that can be controlled by the control unit 250.

The storage unit 240 stores various pieces of data and programs. The storage unit 240 is, for example, a semiconductor memory element such as a RAM or a flash memory, a hard disk, an optical disk, or the like. The storage unit 240 stores information received via the communication unit 210. The storage unit 240 stores, for example, various types of information such as the control information D10 described above. The storage unit 240 may be an external storage device accessible by the client device 200.

The control unit 250 is an arithmetic processing device. The arithmetic processing device includes, for example, a CPU, an SoC, an MCU, an FPGA, and a coprocessor, but is not limited thereto. The control unit 250 is an integrated control unit that controls the client device 200.

Specifically, the control unit 250 executes a command included in the program stored in the storage unit 240 while referring to the information stored in the storage unit 130 as necessary. Then, the control unit 250 controls the functional unit according to the data and the command, thereby implementing various functions. The functional unit includes, for example, the communication unit 210, the decoder 220, the output unit 230, and the like, but is not limited thereto. The control unit 250 has a function of executing a process based on the transmission data D200 from the information processing device 100 by executing a program.

The control unit 250 has a function of generating the control information D10 capable of identifying the amount of transmission based on the video quality, the communication status, and the like necessary for the client device 200. The control unit 250 transmits the generated control information D10 to the information processing device 100 via the communication unit 210. The control unit 250 identifies a hierarchy decoded from the transmission data D200 transmitted by the information processing device 100, and causes the hierarchy of the decoder 220 suitable for the hierarchy to perform decoding.

The functional configuration example of the client device 200 according to the embodiment is described above. Note that the above-described configuration described with reference to FIG. 5 is merely an example, and the functional configuration of the client device 200 according to the embodiment is not limited to such an example. The functional configuration of the client device 200 according to the embodiment can be flexibly modified according to specifications and operations.

### [Encoding Control Example of Information Processing Device]

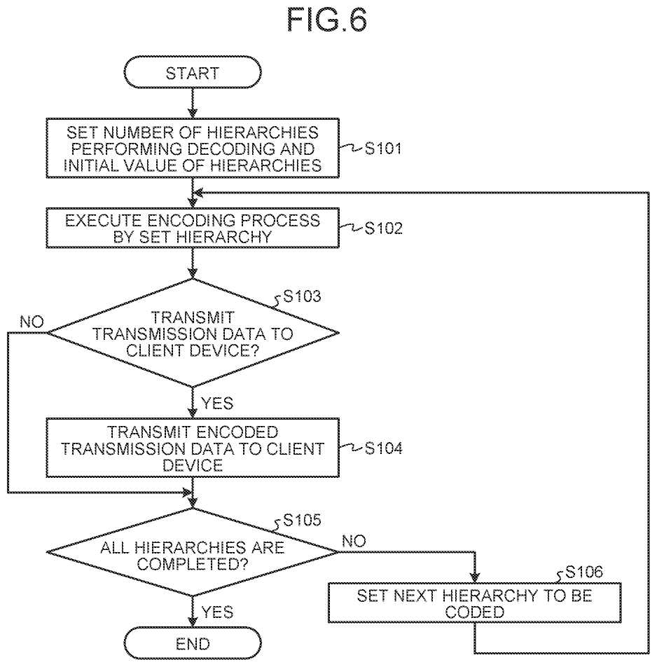

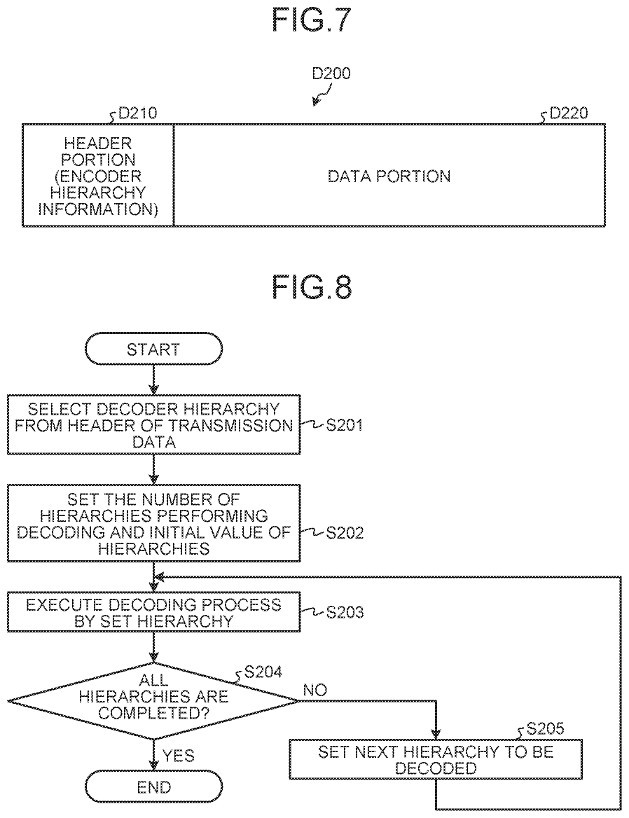

FIG. 6 is a flowchart illustrating an example of a processing procedure related to encoding control of the information processing device 100. FIG. 7 is a diagram illustrating an example of a data structure of the transmission data D200. The processing procedure illustrated in FIG. 6 is realized by the control unit 140 of the information processing device 100 executing a program. The processing procedure illustrated in FIG. 6 is executed in a case where the information processing device 100 transmits (distributes) the content data D100 to the client device 200.

As illustrated in FIG. 6, the control unit 140 of the information processing device 100 sets the number of hierarchies performing decoding and initial values of the hierarchies (step S101). For example, the control unit 140 sets the number of hierarchies of the encoders 120 used for encoding and initial values of the hierarchies. The initial value of the hierarchy is, for example, a value indicating a shallow hierarchy (upper hierarchy). In the present embodiment, the control unit 140 allocates integers of “0”, “1”, “2”, and “3” as values that can identify the hierarchy 121, the hierarchy 122, the hierarchy 123, and the hierarchy 124 illustrated in FIG. 2, respectively. In this case, the control unit 140 sets “0” of the shallow hierarchy 121 as an initial value of the hierarchy, and sets the number of hierarchies to 4. Upon completion of the process in step S101, the control unit 140 advances the process to step S102.

The control unit 140 executes decoding processing by the set hierarchy (step S102). The decoding process includes, for example, a process of inputting data to be transmitted to the encoder 120 and causing a set hierarchy to encode the data. For example, in a case where the set hierarchy is the hierarchy 121, the control unit 140 causes the hierarchy 121 to encode the data to be transmitted. For example, in a case where the set hierarchy is the hierarchy 124, the control unit 140 causes the hierarchy 121, the hierarchy 122, the hierarchy 123, and the hierarchy 124 to encode the data to be transmitted in this order. After storing the encoded data encoded by the encoder 120 in the storage unit 130, the control unit 140 advances the process to step S103.

The control unit 140 determines whether to transmit the transmission data to the client device 200 (step S103). For example, in a case where the set hierarchy matches the hierarchy of the control information D10, the control unit 140 determines to transmit the transmission data to the client device 200. When it is determined that the transmission data is not transmitted to the client device 200 (No in step S103), the control unit 140 advances the process to step S105 described later. In addition, when it is determined that the transmission data is transmit to the client device 200 (Yes in step S103), the control unit 140 advances the process to step S104.

The control unit 140 transmits the encoded transmission data D200 to the client device 200 (step S104). For example, as illustrated in FIG. 7, the control unit 140 sets the hierarchy information indicating the hierarchy of the encoder 120 performing encoding in a header portion D210, and creates the transmission data D200 in which the encoded data encoded by the encoder 120 is set in a data portion D220 in step S102. In the present embodiment, a configuration in which the transmission data D200 includes the header portion D210 and the data portion D220 will be described, but the present invention is not limited thereto. Returning to FIG. 6, the control unit 140 performs control to transmit the created transmission data D200 to the client device 200 via the communication unit 110. Upon completion of the process in step S104, the control unit 140 advances the process to step S105.

The control unit 140 determines whether all the hierarchies are completed (step S105). For example, in a case where the number of set hierarchies is equal to or larger than the number of hierarchies, the control unit 140 determines that all the hierarchies are completed. When it is determined that all the hierarchies are not completed (No in step S105), the control unit 140 advances the process to step S106. The control unit 140 sets the next hierarchy performing encoding (step S106). For example, the control unit 140 changes the setting value of the hierarchy to a value indicating the next hierarchy. When the process of step S106 ends, the control unit 140 returns the process to step S102 described above and continues the process.

In addition, in a case where it is determined that all the hierarchies are completed (Yes in step S105), the control unit 140 ends the processing procedure illustrated in FIG. 6.

As described above, the information processing device 100 can transmit the encoded data decoded into the plurality of amounts of transmission to the client device 200 determined from among the plurality of client devices 200 based on the amounts of transmission of the encoded data. As a result, since the information processing device 100 can control the transmission based on the amounts of transmission of the encoded data, the real-time performance in the one-to-many communication can be improved.

### [Example of Decoding Control of Client Device]

FIG. 8 is a flowchart illustrating an example of a processing procedure related to decoding control of the client device 200. The processing procedure illustrated in FIG. 8 is realized by the control unit 250 of the information processing device 100 executing a program. The processing procedure illustrated in FIG. 8 is executed in a case where the transmission data D200 from the client device 200 is decoded.

As illustrated in FIG. 8, the control unit 250 of the client device 200 selects the hierarchy of the decoder 220 from the header of the transmission data D200 (step S201). For example, the control unit 250 recognizes the hierarchy of the encoder 120 based on the hierarchy information of the header portion D210 of the transmission data D200 received by the communication unit 210, and selects the hierarchy of the decoder 220 corresponding to the hierarchy of the encoder 120. Upon completion of the process in step S201, the control unit 250 advances the process to step S202.

The control unit 250 sets the number of hierarchies performing decoding and initial values of the hierarchies (step S202). For example, the control unit 140 sets the number of hierarchies of the decoder 220 used for decoding and initial values of the hierarchies. As the initial value of the hierarchy, for example, a value indicating the same hierarchy as the hierarchy of the encoder 120 is set. In the present embodiment, the control unit 250 allocates integers of “0”, “1”, “2”, and “3” as values that can identify the hierarchy 221, the hierarchy 222, the hierarchy 223, and the hierarchy 224 illustrated in FIG. 2, respectively. For example, in a case where the transmission data D200 is data encoded by the hierarchy 122 of the encoder 120, the control unit 250 sets the value of the hierarchy 222 as the initial value of the hierarchy and sets the number of hierarchies to two. Upon completion of the process in step S202, the control unit 250 advances the process to step S203.

The control unit 250 executes decoding processing by the set hierarchy (step S203). The decoding process includes, for example, a process of inputting data to be decoded of the transmission data D200 to the decoder 220 and decoding the data to be decoded by a set hierarchy. For example, in a case where the set hierarchy is the hierarchy 222 and the number of hierarchies of the decoder 220 is two, that is, in the case of the decoder 220-1, the control unit 250 decodes the data to be decoded in the hierarchy 222 and stores the decoded data in the storage unit 240. For example, in a case where the set hierarchy is the hierarchy 222 and the number of hierarchies of the decoder 220 is three, that is, in the case of the decoder 220-2, the control unit 250 decodes, as data to be decoded, the encoded data stored in the storage unit 240 by the hierarchy 222, and stores the decoded data in the storage unit 240. Upon completion of the process in step S203, the control unit 250 advances the process to step S204.

The control unit 250 determines whether all the hierarchies are completed (step S204). For example, in a case where the value of the set hierarchy is smaller than 0, the control unit 250 determines that all the hierarchies are completed. When it is determined that all the hierarchies are not completed (No in step S204), the control unit 250 advances the process to step S205. The control unit 250 sets the next hierarchy performing encoding (step S205). For example, the control unit 250 changes the setting value of the hierarchy to a value indicating the next hierarchy. When the process of step S205 ends, the control unit 250 returns the process to step S203 described above and continues the process.

When it is determined that all the hierarchies are completed (Yes in step S204), the control unit 250 ends the processing procedure illustrated in FIG. 8.

As described above, the information processing system 1 can transmit the encoded data decoded by the information processing device 100 into a plurality of amounts of transmission to the client device 200 determined from among the plurality of client devices 200 based on the amounts of transmission of the encoded data. In the information processing system 1, each of the plurality of client devices 200 can decode the encoded data of the amount of transmission to be decoded. As a result, in the information processing system 1, since the information processing device 100 can control the transmission based on the amounts of transmission of the encoded data, the real-time performance in the one-to-many communication can be improved.

### Modification of Embodiment

### [Modification of Information Processing System]

The case where, in the information processing system 1 described above, the encoded transmission data D200 encoded by each hierarchy of the encoder 120 is transmitted as it is, is described, but the present invention is not limited thereto. For example, the information processing system 1 can be configured to compress and transmits the transmission data D200 encoded by each hierarchy of the encoder 120.

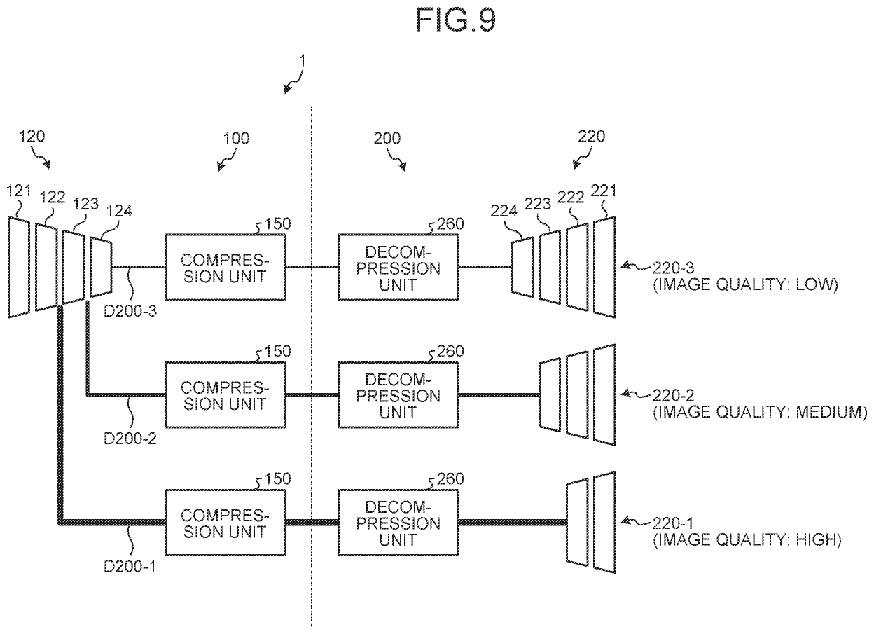

FIG. 9 is a diagram illustrating an outline of a configuration example of the information processing system 1 according to a modification of the embodiment. As illustrated in FIG. 9, the information processing system 1 described above can add a compression unit 150 that compresses the transmission data D200 encoded by the encoder 120 of the information processing device 100 and a decompression unit 260 that decompresses the transmission data D200 transmitted by the information processing device 100 to the configurations of the information processing device 100 and the client device 200.

The information processing device 100 may include one or a plurality of compression units 150. The compression unit 150 is electrically connected to at least the encoder 120 and the control unit 140. In the example illustrated in FIG. 9, the information processing device 100 includes three compression units 150 that compress the transmission data D200-1, the transmission data D200-2, and the transmission data D200-3 output from the hierarchy 122, the hierarchy 123, and the hierarchy 124 of the encoder 120, respectively. The compression unit 150 compresses data using a known compression technique. The control unit 140 transmits the transmission data D200 compressed by the compression unit 150 to the client device 200. The control unit 140 sets, for example, compression information indicating whether compression is performed, the type of compression technology, and the like in the header portion D210 of the transmission data D200.

The client device 200 may include one or a plurality of decompression units 260. The decompression unit 260 is electrically connected to at least the decoder 220 and the control unit 250. In the example illustrated in FIG. 9, the client device 200 includes three decompression units 260 corresponding to the decoder 220-1, the decoder 220-2, and the decoder 220-3. The decompression unit 260 decompresses the transmission data D200 using a decompression technology corresponding to the compression unit 150. The decompression unit 260 decompresses the data in a case where the compression information in the header portion D210 of the transmission data D200 indicates that the data is compressed. The control unit 250 causes the decoder 220 to decode the transmission data D200 decompressed by the decompression unit 260. The transmission data D200 decompressed by the decompression unit 260 is input to the decoder 220-1, the decoder 220-2, and the decoder 220-3.

In the example illustrated in FIG. 9, in the information processing system 1, a case where the information processing device 100 includes three compression units 150 and the client device 200 includes three decompression units 260 will be described, but the present invention is not limited thereto. For example, the information processing system 1 may be configured such that three pieces of transmission data D200-1, transmission data D200-2, and transmission data D200-3 are compressed by one compression unit 150 of the information processing device 100 and decompressed by one decompression unit 260 of the client device 200. For example, the information processing system 1 may be configured to compress and decompress only the transmission data D200-1 having a large amount of transmission.

### [Encoding Control Example of Information Processing Device According to Modification of Embodiment]

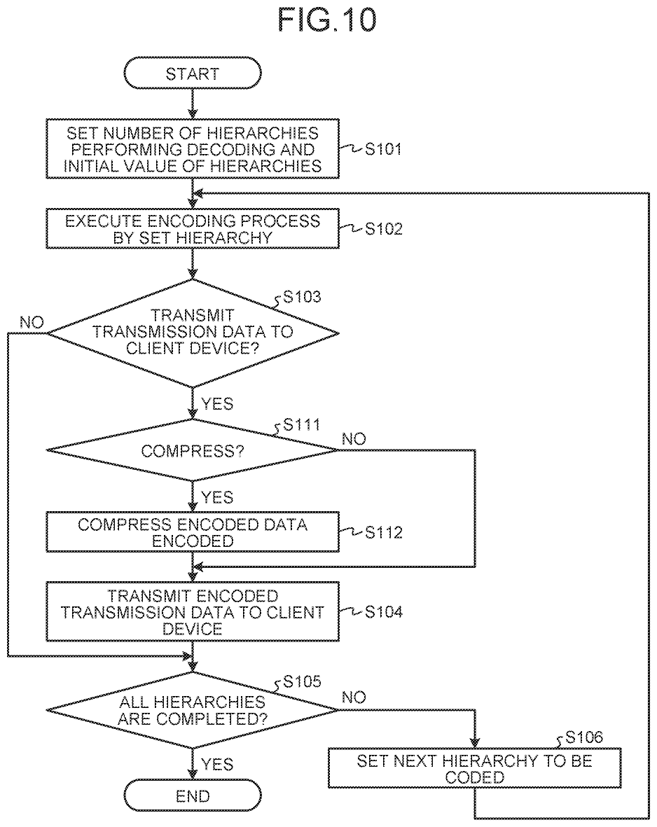

FIG. 10 is a flowchart illustrating an example of a processing procedure related to encoding control of the information processing device 100 according to a modification of the embodiment. FIG. 10 is a diagram illustrating an example of a data structure of the transmission data D200. The processing procedure illustrated in FIG. 10 is realized by the control unit 140 of the information processing device 100 executing a program. The processing procedure illustrated in FIG. 10 is executed in a case where the information processing device 100 transmits (distributes) the content data D100 to the client device 200. In the processing procedure illustrated in FIG. 10, the same processes as those in the processing procedure illustrated in FIG. 6 are denoted by the same reference numerals, and description thereof is omitted.

As illustrated in FIG. 10, the control unit 140 of the information processing device 100 sets the number of hierarchies performing decoding and initial values of the hierarchies (step S101). The control unit 140 executes decoding processing by the set hierarchy (step S102). The control unit 140 determines whether to transmit the transmission data to the client device 200 (step S103). When it is determined that the transmission data is not transmitted to the client device 200 (No in step S103), the control unit 140 advances the process to step S105 described later. In addition, when it is determined that the transmission data is transmitted to the client device 200 (Yes in step S103), the control unit 140 advances the process to step S111.

The control unit 140 determines whether to compress (step S111). For example, in a case where the compression unit 150 is present, in a case where the compression setting is valid, or the like, the control unit 140 determines to perform compression. When it is determined that compression is not performed (No in step S111), the control unit 140 advances the process to step S104.

On the other hand, when it is determined that compression is performed (Yes in step S111), the control unit 140 advances the process to step S112. The control unit 140 compresses the encoded data encoded (step S112). For example, the control unit 140 compresses the encoded data set in the data portion D220 of the encoder 120 in step S102 by the compression unit 150. Upon completion of the process in step S112, the control unit 140 advances the process to step S104.

The control unit 140 transmits the encoded transmission data D200 to the client device 200 (step S104). For example, in a case where compression is performed in step S112, the control unit 140 sets the hierarchy information and the compression information in the header portion D210, and creates the transmission data D200 in which the encoded data encoded by the encoder 120 is set in the data portion D220 in step S102. The control unit 140 performs control to transmit the created transmission data D200 to the client device 200 via the communication unit 110. Upon completion of the process in step S104, the control unit 140 advances the process to step S105.

The control unit 140 determines whether all the hierarchies are completed (step S105). When it is determined that all the hierarchies are not completed (No in step S105), the control unit 140 advances the process to step S106. The control unit 140 sets the next hierarchy performing encoding (step S106). When the process of step S106 ends, the control unit 140 returns the process to step S102 and continues the process.

In addition, when it is determined that all the hierarchies are completed (Yes in step S105), the control unit 140 ends the processing procedure illustrated in FIG. 10.

### [Decoding Control Example of Client Device According to Modification of Embodiment]

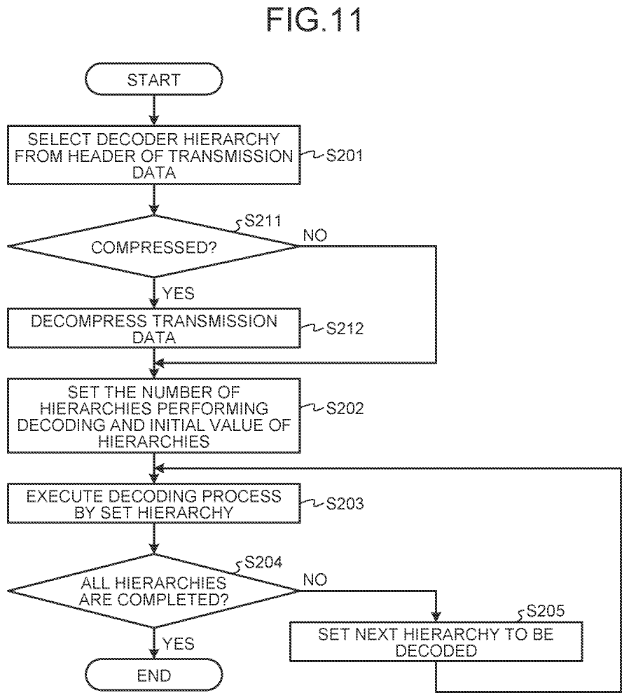

FIG. 11 is a flowchart illustrating an example of a processing procedure related to decoding control of the client device 200 according to the modification of the embodiment. The processing procedure illustrated in FIG. 11 is realized by the control unit 250 of the information processing device 100 executing a program. The processing procedure illustrated in FIG. 11 is executed in a case where the transmission data D200 from the client device 200 is decoded. In the processing procedure illustrated in FIG. 11, the same processes as those in the processing procedure illustrated in FIG. 8 are denoted by the same reference numerals, and description thereof is omitted.

As illustrated in FIG. 11, the control unit 250 of the client device 200 selects the hierarchy of the decoder 220 from the header of the transmission data D200 (step S201). Upon completion of the process in step S201, the control unit 250 advances the process to step S211.

The control unit 250 determines whether compression is performed (step S211). For example, the control unit 250 determines that the transmission data D200 is compressed when the compression information in the header portion D210 of the transmission data D200 indicates that the transmission data D is compressed. When it is determined that compression is performed (No in step S211), the control unit 250 advances the process to step S202.

In addition, when it is determined that compression is performed (Yes in step S211), the control unit 250 advances the process to step S212. The control unit 140 decompresses the transmission data D200 (step S212). For example, the control unit 250 causes the decompression unit 260 to decompress the transmission data D200. Upon completion of the process in step S212, the control unit 250 advances the process to step S202.

The control unit 250 sets the number of hierarchies performing decoding and initial values of the hierarchies (step S202). The control unit 250 executes decoding processing by the set hierarchy (step S203). The control unit 250 determines whether all the hierarchies are completed (step S204). When it is determined that all the hierarchies are not completed (No in step S204), the control unit 250 advances the process to step S205. The control unit 250 sets the next hierarchy performing encoding (step S205). When the process of step S205 ends, the control unit 250 returns the process to step S203 described above and continues the process.

In addition, when it is determined that all the hierarchies are completed (Yes in step S204), the control unit 250 ends the processing procedure illustrated in FIG. 11.

As described above, the information processing system 1 can further reduce the amount of transmission between the information processing device 100 and the client device 200. As a result, the information processing system 1 can further improve the real-time performance since the amount of transmission in the one-to-many communication is reduced.

### [Usage Example of Temporal Direction Prediction of Information Processing System 1]

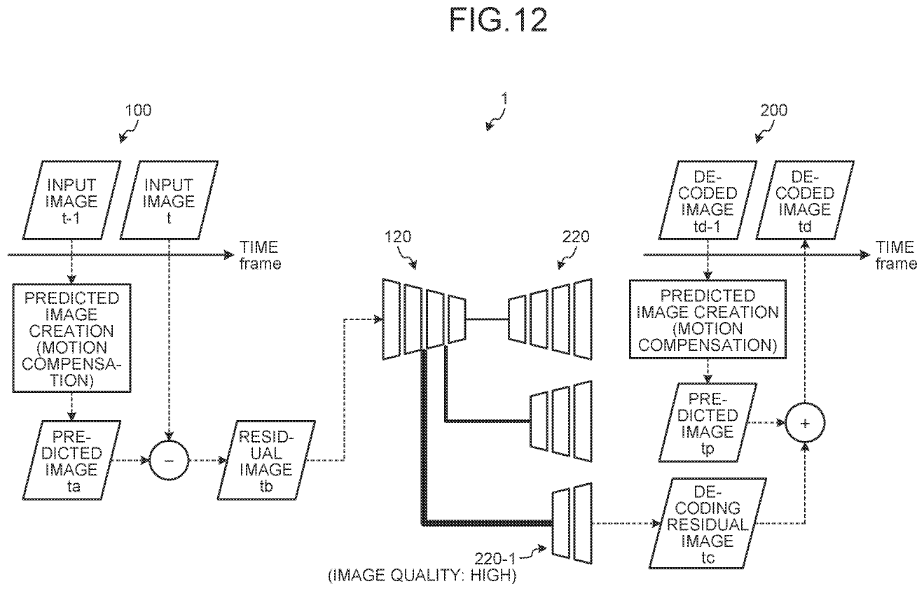

FIG. 12 is a diagram for describing a usage example of temporal direction prediction of the information processing system 1. As illustrated in FIG. 12, the information processing system 1 can increase the coding efficiency by using the unidirectional prediction using only the past input image. In the example illustrated in FIG. 12, an input image t and an input image t-1 indicate images at different times.

The information processing device 100 creates a predicted image ta based on the input image t-1. The information processing device 100 creates the predicted image ta obtained by predicting the current frame from the input image t-1 of the previous frame based on the property of the moving image that the previous frame and the current frame are very similar. In the inter-frame prediction, the information processing device 100 can use a motion compensation technique in order to increase compression efficiency. The motion compensation compensates for the motion by using an image at a position shifted by the motion when predicting the current frame. The information processing device 100 inputs the residual image tb of the input image t and the predicted image ta to the encoder 120 to transmit the transmission data D200 decoded by the encoder 120 to the client device 200.

The client device 200 decodes the transmission data D200 from the information processing device 100 by the decoder 220. The client device 200 creates a predicted image tp based on a decoded image td-1. When obtaining a decoded residual image tc decoded by the decoder 220, the client device 200 obtains a decoded image td based on the decoded residual image tc and the predicted image tp. The client device 200 performs control related to the decoded image td.

In the information processing system 1, the encoder 120 is only required to encode the residual image tb by using the unidirectional prediction using the past frame, and can improve the encoding efficiency. In this case, since the error is accumulated in the frame direction, the information processing system 1 can eliminate the accumulation of the error by periodically inserting an intra-frame that does not use the temporal direction prediction.

### [Example of Training Method of Auto Encoder of Information Processing System 1]

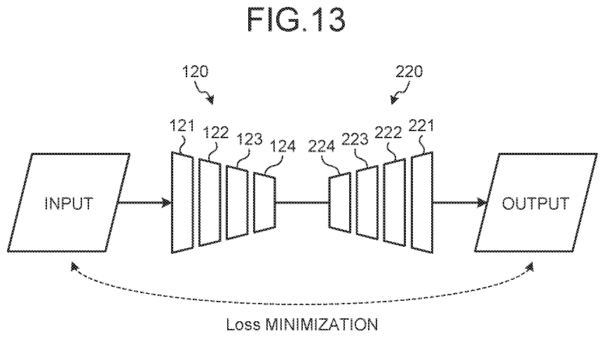

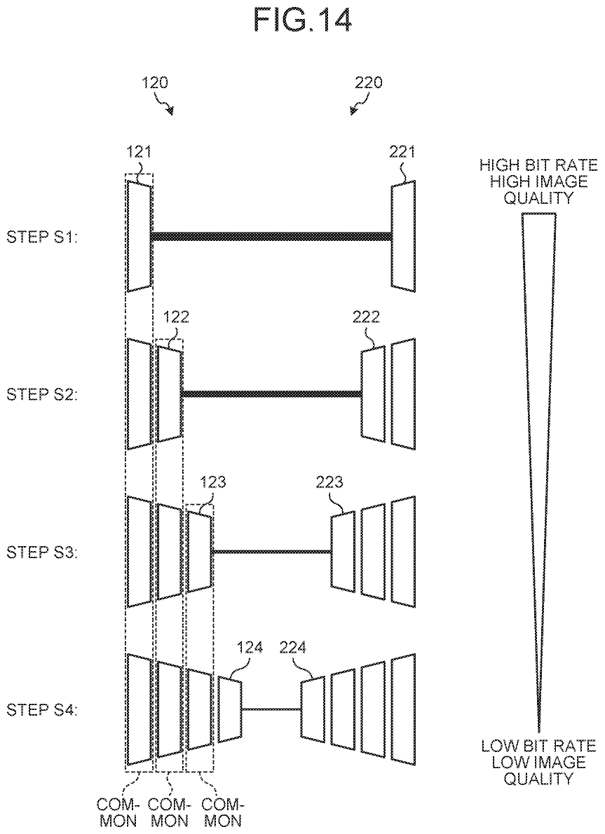

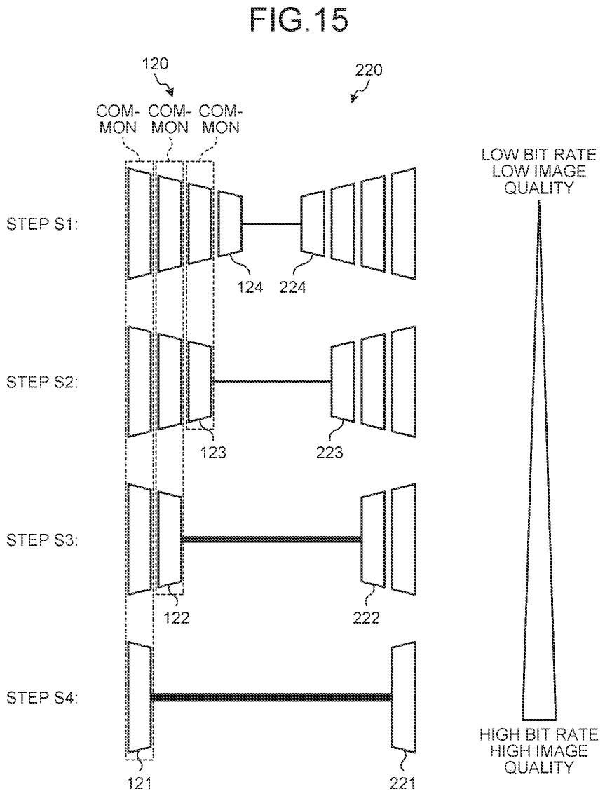

FIG. 13 is a diagram for describing an example of a training method of the auto encoder of the information processing system 1. FIG. 14 is a diagram for describing an example of a training method of an auto encoder with priority given to a high bit rate. FIG. 15 is a diagram for describing an example of a training method of an auto encoder with priority given to a low bit rate.

As illustrated in FIG. 13, the information processing system 1 uses an auto encoder that was trained to reduce Loss between the input of the encoder 120 and the output of the decoder 220. The information processing system 1 can appropriately use a loss function such as L1 loss, for example. Since the shallow layer of the encoder 120 is common, optimization cannot be performed for all the transmission data D200, but the image quality to be prioritized can be changed by changing the training step.

As illustrated in FIG. 14, in a case where high image quality at a high bit rate is prioritized, the information processing system 1 trains the hierarchy 121 of the encoder 120 and the hierarchy 221 of the decoder 220 in step S1. The information processing system 1 inputs the training signal to the hierarchy 121, and generates a parameter to be used for the hierarchy 121 of the encoder 120 and the hierarchy 221 of the decoder 220 based on the training signal so as to reduce loss.

In step S2, the information processing system 1 trains the hierarchy 122 of the encoder 120 and the hierarchy 222 of the decoder 220. Since the hierarchy 121 of the encoder is common, the information processing system 1 inputs the training signal to the hierarchy 121, and generates a parameter to be used for the hierarchy 122 of the encoder 120 and the hierarchy 222 of the decoder 220 based on the training signal so as to reduce loss.

In step S3, the information processing system 1 trains the hierarchy 123 of the encoder 120 and the hierarchy 223 of the decoder 220. Since the hierarchy 121 and the hierarchy 122 of the encoder are common, the information processing system 1 inputs the training signal to the hierarchy 121, and generates a parameter to be used for the hierarchy 123 of the encoder 120 and the hierarchy 223 of the decoder 220 based on the training signal so as to reduce loss.

In step S4, the information processing system 1 trains the hierarchy 124 of the encoder 120 and the hierarchy 224 of the decoder 220. Since the hierarchy 121, the hierarchy 122, and the hierarchy 123 of the encoder are common, the information processing system 1 inputs the training signal to the hierarchy 121, and generates a parameter to be used for the hierarchy 124 of the encoder 120 and the hierarchy 224 of the decoder 220 based on the training signal so as to reduce loss.

The information processing system 1 can use the encoder 120 and the decoder 220 with priority given to high image quality of a high bit rate by setting the parameters generated by the training illustrated in FIG. 14 in each hierarchy of the encoder 120 and the decoder 220.

As illustrated in FIG. 15, in a case where low image quality at a low bit rate is prioritized, the information processing system 1 trains the hierarchy 121, the hierarchy 122, the hierarchy 123, and the hierarchy 124 of the encoder 120 and the hierarchy 221, the hierarchy 222, the hierarchy 223, and the hierarchy 224 of the decoder 220 in step S1. The information processing system 1 inputs the training signal to the hierarchy 121, and generates a parameter to be used for the hierarchy 121, the hierarchy 122, the hierarchy 123, and the hierarchy 124 of the encoder 120 and the hierarchy 221, the hierarchy 222, the hierarchy 223, and the hierarchy 224 of the decoder 220 based on the training signal so as to reduce loss.

In step S2, the information processing system 1 trains the hierarchy 121, the hierarchy 122, and the hierarchy 123 of the encoder 120 and the hierarchy 221, the hierarchy 222, and the hierarchy 223 of the decoder 220. Since each hierarchy of the encoder 120 is common to step S11, the information processing system 1 generates a parameter to be used for each hierarchy of the encoder 120 and the decoder 220 based on the training result of step S11 so as to reduce loss.

In step S3, the information processing system 1 trains the hierarchy 121 and the hierarchy 122 of the encoder 120 and the hierarchy 221 and the hierarchy 222 of the decoder 220. Since each hierarchy of the encoder 120 is common to step S11, the information processing system 1 generates a parameter to be used for each hierarchy of the encoder 120 and the decoder 220 based on the training result of step S11 so as to reduce loss.

In step S4, the information processing system 1 trains the hierarchy 121 of the encoder 120 and the hierarchy 221 of the decoder 220. Since the hierarchy 121 of the encoder 120 is common to step S11, the information processing system 1 generates a parameter to be used for the hierarchy 121 of the encoder 120 and the hierarchy 221 of the decoder 220 based on the training result of step S11 so as to reduce loss.

The information processing system 1 can use the encoder 120 and the decoder 220 with priority given to low image quality of a low bit rate by setting the parameters generated by the training illustrated in FIG. 15 in each hierarchy of the encoder 120 and the decoder 220.

### [Another Modification of Information Processing System]

In the above-described embodiment, the configuration in which the information processing system 1 includes the information processing device 100 and the plurality of client devices 200 is described, but the present invention is not limited thereto. For example, the information processing system 1 may include the information processing device 100, and one client device 200 including a plurality of decoder 220-1, decoder 220-2, and decoder 220-3. That is, the information processing system 1 may implement one-to-many communication in a one-to-one configuration between the information processing device 100 and the client device 200.

### [Hardware Configuration]

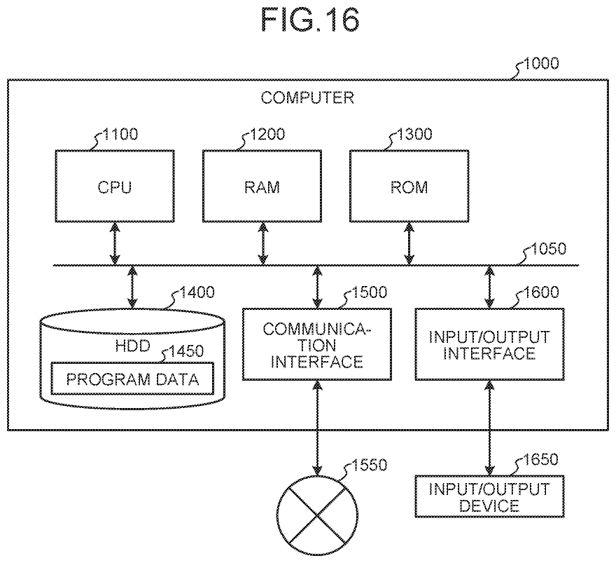

The information processing device 100 and the client device 200 of the information processing system 1 according to the above-described embodiment may be realized by, for example, a computer 1000 having a configuration as illustrated in FIG. 16. Hereinafter, the information processing device 100 according to the embodiment will be described as an example. FIG. 16 is a hardware configuration diagram illustrating an example of the computer 1000 that implements the functions of the information processing device 100. The computer 1000 includes a CPU 1100, a RAM 1200, a read only memory (ROM) 1300, a hard disk drive (HDD) 1400, a communication interface 1500, and an input/output interface 1600. Respective units of the computer 1000 are connected by a bus 1050.

The CPU 1100 operates based on a program stored in the ROM 1300 or the HDD 1400, and controls each unit. For example, the CPU 1100 develops a program stored in the ROM 1300 or the HDD 1400 in the RAM 1200, and performs a process corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records programs executed by the CPU 1100, data used by the programs, and the like. Specifically, the HDD 1400 is a recording medium that records an information processing program according to the present disclosure which is an example of program data 1450.

The communication interface 1500 is an interface for the computer 1000 to be connected to an external network 1550 (for example, the Internet). For example, the CPU 1100 receives data from another device or transmits data generated by the CPU 1100 to another device via the communication interface 1500.

The input/output interface 1600 is an interface that connects an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD), a magneto-optical recording medium such as a magneto-optical disk (MO), a tape medium, a magnetic recording medium, a semiconductor memory, or the like.

For example, in a case where the computer 1000 functions as the information processing device 100 of the information processing system 1 according to the embodiment, the CPU 1100 of the computer 1000 realizes the functions of the control unit 140 and the like by executing a program loaded on the RAM 1200. In addition, the HDD 1400 stores a program according to the present disclosure and data in the storage unit 130. The CPU 1100 reads the program data 1450 from the HDD 1400 and executes the program data, but as another example, the program may be acquired from another device via the external network 1550.

Although the preferred embodiments of the present disclosure have been described in detail with reference to the accompanying drawings, the technical scope of the present disclosure is not limited to such examples. It is obvious that those skilled in the art in the technical field of the present disclosure can find various revisions and modifications within the scope of a technical concept described in claims, and it should be understood that these revisions and modifications will also be naturally come under the technical scope of the present disclosure.

Furthermore, the effects described in the present specification are merely illustrative or exemplified effects, and are not limitative. That is, the technique according to the present disclosure can accomplish other effects apparent to those skilled in the art from the description of the present specification, in addition to or instead of the effects described above.

Furthermore, it is also possible to create a program for causing hardware such as a CPU, a ROM, and a RAM built in a computer to exhibit a function equivalent to the configuration of the information processing device 100, and a computer-readable recording medium recording the program can also be provided.

Furthermore, each step related to the processing of the information processing device 100 of the present specification is not necessarily processed in time series in the order described in the flowchart. For example, each step related to the processing of the information processing device 100 may be processed in an order different from the order described in the flowchart, or may be processed in parallel.

### Effects

The information processing system 1 includes the information processing device 100 and a plurality of client devices 200. The information processing device 100 includes the encoder 120 that encodes data to be transmitted to encoded data of a plurality of different amounts of transmission, and the control unit 140 that performs control to transmit the encoded data encoded to the client device 200 determined from among the plurality of client devices 200 based on the amounts of transmission of the encoded data. The client device 200 includes the decoder 220 that is adjusted to an amount of transmission to be decoded and decodes encoded data, and the control unit 250 (second control unit) that performs a process based on the decoded data.

As a result, the information processing system 1 can transmit the encoded data decoded by the information processing device 100 into a plurality of amounts of transmission to the client device 200 determined from among the plurality of client devices 200 based on the amounts of transmission of the encoded data. In the information processing system 1, each of the plurality of client devices 200 can decode the encoded data of the amount of transmission to be decoded. As a result, in the information processing system 1, since the information processing device 100 can control the transmission based on the amounts of transmission of the encoded data, the real-time performance in the one-to-many communication can be improved.

In the information processing system 1, the information processing device 100 includes a plurality of hierarchies that performs encoding so that the encoder 120 has different amounts of transmission, and the control unit 140 transmits the encoded data encoded by each of the plurality of hierarchies to the client device 200 determined from among the plurality of client devices 200 based on the amounts of transmission of the encoded data. In the client device 200, the decoder 220 is adjusted to different amounts of transmission of a plurality of hierarchies in the encoder 120.

As a result, in the information processing system 1, the encoder 120 of the information processing device 100 can include a plurality of hierarchies, and the client device 200 can include a decoder suitable for different amounts of transmission of the plurality of hierarchies. As a result, in the information processing system 1, since the plurality of client devices 200 is only required to include the decoder 220 suitable for the amount of transmission, it is possible to improve the real-time performance in the one-to-many communication and to simplify the configuration of the client device 200.

In the information processing system 1, the information processing device 100 further encodes the encoded data encoded by a previous hierarchy of the plurality of hierarchies to reduce the amount of transmission, and every time the plurality of hierarchies performs encoding, the control unit 140 transmits the encoded data encoded to the client device 200 determined from among the plurality of client devices 200 based on the amounts of transmission of the encoded data.

As a result, every time a plurality of hierarchies of the encoder 120 in the information processing device 100 performs decoding, the information processing system 1 can sequentially transmit encoded data from the encoded data having a large amount of transmission to the client device 200 suitable for the amount of transmission. As a result, the information processing system 1 can further improve the real-time performance in the one-to-many communication by sequentially transmitting the encoded data obtained by encoding the data to be transmitted in stages.

In the information processing system 1, in the information processing device 100, the control unit 140 determines the client device 200 to which the encoded data is transmitted based on the amount of transmission indicated by the control information D10 from the client device 200. In the client device 200, the control unit 250 performs control to transmit the control information D10 to the information processing device 100.

As a result, in the information processing system 1, the client device 200 transmits the control information D10 indicating the amount of transmission suitable for the client device to the information processing device 100, so that the information processing device 100 can transmit the encoded data of the amount of transmission suitable for each of the plurality of client devices 200. As a result, in the information processing system 1, since the information processing device 100 can efficiently control the transmission based on the amounts of transmission of the encoded data, the real-time performance in the one-to-many communication can be further improved.

In the information processing system 1, in the information processing device 100, the control unit 140 transmits, to the client device 200, the transmission data D200 having the encoded data and the hierarchy information capable of identifying the hierarchy encoded. In the client device 200, the control unit 250 controls decoding based on the hierarchy information.

As a result, in the information processing system 1, the information processing device 100 transmits the transmission data D200 having the hierarchy information to the client device 200, so that the client device 200 can control decoding of the transmission data D200 based on the hierarchy information. As a result, in the information processing system 1, since the client device 200 can perform decoding by switching the hierarchy of the decoder 220 according to the transmission data D200, the versatility of the client device 200 can be improved.

In the information processing system 1, in the client device 200, the decoder 220 includes one or a plurality of hierarchies, and performs decoding by a hierarchy corresponding to the encoder 120.

As a result, in the information processing system 1, the client device 200 can decode the transmission data of the amount of transmission to be decoded by the hierarchy of the decoder 220. As a result, in the information processing system 1, since the client device 200 can decode the encoded data of different amounts of transmission, the system configuration in the one-to-many communication can be diversified.

In the information processing system 1, the control unit 140 of the information processing device 100 compresses encoded data encoded by the hierarchy of the encoder 120 to transmit the compressed encoded data to the client device 200. The client device 200 decodes data obtained by decompressing the encoded data from the information processing device 100 by the decoder 220.

As a result, the information processing system 1 can further reduce the amount of transmission between the information processing device 100 and the client device 200. As a result, the information processing system 1 can further improve the real-time performance since the amount of transmission in the one-to-many communication is reduced.

In the information processing system 1, the data to be transmitted includes data indicating a residual image.

As a result, in the information processing system 1, the encoder 120 can encode the residual image by using the unidirectional prediction using the past frame. As a result, the information processing system 1 can improve the encoding efficiency by the encoder 120 encoding the residual image tb.

In the information processing system 1, the encoder 120 and the decoder 220 are trained with priority given to a high bit rate or a low bit rate.

As a result, the information processing system 1 can use the encoder 120 and the decoder 220 that were trained with priority given to the high bit rate or the low bit rate. As a result, since the information processing system 1 can change the quality of the prioritized transmission data D200, the system can be optimized.

The information processing device 100 is capable of communicating with a plurality of client devices 200, and the information processing device 100 includes the encoder 120 that encodes data to be transmitted to a plurality of pieces of encoded data having different amounts of transmission, and the control unit 140 that performs control to transmit the encoded data encoded to the client device 200 determined from among the plurality of client devices 200 based on the amounts of transmission of the encoded data.

As a result, the information processing device 100 can transmit the encoded data decoded into a plurality of amounts of transmission to the client device 200 determined from among the plurality of client devices 200 based on the amounts of transmission of the encoded data. As a result, since the information processing device 100 can control the transmission based on the amounts of transmission of the encoded data, the real-time performance in the one-to-many communication can be improved.

An information processing method includes the information processing device 100 capable of communicating with a plurality of client devices 200 encoding data to be transmitted to a plurality of pieces of encoded data having different amounts of transmission by the encoder 120, and performing control to transmit the encoded data encoded to the client device 200 determined from among the plurality of client devices 200 based on the amounts of transmission of the encoded data.

As a result, according to the information processing method, the information processing device 100 can transmit the encoded data decoded into a plurality of amounts of transmission to the client device 200 determined from among the plurality of client devices 200 based on the amounts of transmission of the encoded data. As a result, since the information processing method can control the transmission based on the amounts of transmission of the encoded data, the real-time performance in the one-to-many communication can be improved.

Note that the following configuration also belong to the technical scope of the present disclosure.

(1)

An information processing system comprising:
an information processing device; and
a plurality of client devices, wherein
the information processing device includes
an encoder that encodes data to be transmitted to encoded data of a plurality of different amounts of transmission, and
a control unit that performs control to transmit the encoded data encoded to a client device determined from among the plurality of client devices based on the amounts of transmission of the encoded data, wherein
each of the client devices includes
a decoder that is adjusted to an amount of transmission to be decoded and decodes the encoded data, and
a second control unit that performs a process based on the decoded data.
   (2)

The information processing system according to (1), wherein
in the information processing device,
the encoder includes a plurality of hierarchies that performs encoding so as to obtain the different amounts of transmission, and
the control unit transmits the encoded data encoded by each of the plurality of hierarchies to a client device determined from among a plurality of client devices based on the amounts of transmission of the encoded data, and wherein
in the client devices,
the respective decoders are adjusted to the different amounts of transmission for the plurality of hierarchies of the encoder.
   (3)

The information processing system according to (2), wherein
in the information processing device,
the plurality of hierarchies further encodes the encoded data encoded by a previous hierarchy to reduce the amount of transmission, and
the control unit transmits the encoded data encoded to a client device determined from among a plurality of client devices based on the amounts of transmission of the encoded data every time the plurality of hierarchies performs encoding.
   (4)

The information processing system according to any one of (1) to (3), wherein
in the information processing device,
the control unit determines a client device that transmits the encoded data based on the amounts of transmission indicated by control information from the client devices, and wherein
in each of the client device,
the second control unit performs control to transmit the control information to the information processing device.
   (5)

The information processing system according to any one of (1) to (4), wherein
in the information processing device,
the control unit transmits, to the respective client devices, transmission data including the encoded data and hierarchy information capable of identifying a hierarchy that performed encoding, and wherein
in each of the client device,
the second control unit controls decoding based on the hierarchy information.
   (6)

The information processing system according to (5), wherein
in each of the client device,
the decoder includes one or a plurality of second hierarchies, and performs decoding by the second hierarchies corresponding to the hierarchies of the encoder.
   (7)

The information processing system according to any one of (1) to (6), wherein
in each of the information processing device,
the control unit compresses the encoded data encoded by the hierarchies to transmit the compressed encoded data to the client devices, and wherein
in each of the client device,
the decoder decodes data obtained by decompressing the encoded data from the information processing device.
   (8)

The information processing system according to any one of (1) to (7), wherein
the data to be transmitted includes data indicating a residual image.
   (9)

The information processing system according to any one of (1) to (8), wherein
the encoder and the decoders are trained with priority given to a high bit rate or a low bit rate.
   (10)

An information processing device capable of communicating with a plurality of client devices, the information processing device comprising:
an encoder that encodes data to be transmitted to a plurality of pieces of encoded data having different amounts of transmission; and
a control unit that performs control to transmit the encoded data encoded to a client device determined from among a plurality of client devices based on the amounts of transmission of the encoded data.
   (11)

An information processing method comprising:
an information processing device capable of communicating with a plurality of client devices
encoding data to be transmitted to a plurality of pieces of encoded data having different amounts of transmission by an encoder; and
performing control to transmit the encoded data encoded to a client device determined from among a plurality of client devices based on the amounts of transmission of the encoded data.
   (12)

An information processing program for causing an information processing device capable of communicating with a plurality of client devices to execute encoding data to be transmitted to a plurality of pieces of encoded data having different amounts of transmission by an encoder, and performing control to transmit the encoded data encoded to a client device determined from among a plurality of client devices based on the amounts of transmission of the encoded data.

### REFERENCE SIGNS LIST

1 INFORMATION PROCESSING SYSTEM
100 INFORMATION PROCESSING DEVICE
110 COMMUNICATION UNIT
120 ENCODER
121, 122, 123, 124 HIERARCHY
130 STORAGE UNIT
140 CONTROL UNIT
150 COMPRESSION UNIT
200, 200A, 200B, 200C CLIENT DEVICE
210 COMMUNICATION UNIT
220, 220-1, 220-2, 220-3 DECODER
221, 222, 223, 224 HIERARCHY
230 OUTPUT UNIT
240 STORAGE UNIT
250 CONTROL UNIT
260 decompression unit
D10 CONTROL INFORMATION
D100 CONTENT DATA
D200, D200-1, D200-2, D200-3 TRANSMISSION DATA
D210 HEADER PORTION
D220 DATA PORTION

1. An information processing system comprising:
an information processing device; and
a plurality of client devices, wherein
the information processing device includes
an encoder that encodes data to be transmitted to encoded data of a plurality of different amounts of transmission, and
a control unit that performs control to transmit the encoded data encoded to a client device determined from among the plurality of client devices based on the amounts of transmission of the encoded data, wherein
each of the client devices includes
a decoder that is adjusted to an amount of transmission to be decoded and decodes the encoded data, and
a second control unit that performs a process based on the decoded data.

2. The information processing system according to claim 1, wherein
in the information processing device,
the encoder includes a plurality of hierarchies that performs encoding so as to obtain the different amounts of transmission, and
the control unit transmits the encoded data encoded by each of the plurality of hierarchies to a client device determined from among a plurality of client devices based on the amounts of transmission of the encoded data, and wherein
in the client devices,
the respective decoders are adjusted to the different amounts of transmission for the plurality of hierarchies of the encoder.

3. The information processing system according to claim 2, wherein
in the information processing device,
the plurality of hierarchies further encodes the encoded data encoded by a previous hierarchy to reduce the amount of transmission, and
the control unit transmits the encoded data encoded to a client device determined from among a plurality of client devices based on the amounts of transmission of the encoded data every time the plurality of hierarchies performs encoding.

4. The information processing system according to claim 3, wherein
in the information processing device,
the control unit determines a client device that transmits the encoded data based on the amounts of transmission indicated by control information from the client devices, and wherein
in each of the client device,
the second control unit performs control to transmit the control information to the information processing device.

5. The information processing system according to claim 4, wherein
in the information processing device,
the control unit transmits, to the respective client devices, transmission data including the encoded data and hierarchy information capable of identifying a hierarchy that performed encoding, and wherein
in each of the client device,
the second control unit controls decoding based on the hierarchy information.

6. The information processing system according to claim 5, wherein
in each of the client device,
the decoder includes one or a plurality of second hierarchies, and performs decoding by the second hierarchies corresponding to the hierarchies of the encoder.

7. The information processing system according to claim 6, wherein
in each of the information processing device,
the control unit compresses the encoded data encoded by the hierarchies to transmit the compressed encoded data to the client devices, and wherein
in each of the client device,
the decoder decodes data obtained by decompressing the encoded data from the information processing device.

8. The information processing system according to claim 1, wherein
the data to be transmitted includes data indicating a residual image.

9. The information processing system according to claim 1, wherein
the encoder and the decoders are trained with priority given to a high bit rate or a low bit rate.

10. An information processing device capable of communicating with a plurality of client devices, the information processing device comprising:
an encoder that encodes data to be transmitted to a plurality of pieces of encoded data having different amounts of transmission; and
a control unit that performs control to transmit the encoded data encoded to a client device determined from among a plurality of client devices based on the amounts of transmission of the encoded data.

11. An information processing method comprising:
an information processing device capable of communicating with a plurality of client devices
encoding data to be transmitted to a plurality of pieces of encoded data having different amounts of transmission by an encoder; and
performing control to transmit the encoded data encoded to a client device determined from among a plurality of client devices based on the amounts of transmission of the encoded data.
